(19) United States
(12) Patent Application Publication
(10) Pub. No.: US 2026/0296559 A1
(43) Pub. Date: Oct. 1, 2026

(54) Front Storage Space for an Electrically Drivable Motor Vehicle

(71) Applicant: Mercedes-Benz Group AG, Stuttgart (DE)

(72) Inventors: Patrick MANGOLD, Erkenbrechtsweiler (DE); Ludger WILLENBRINK, Boeblingen (DE)

(21) Appl. No.: 19/480,539

(22) PCT Filed: Apr. 5, 2024
(86) PCT No.: PCT/EP2024/059274

§ 371 Date: Oct. 31, 2025

(30) Foreign Application Priority Data
May 2, 2023 (DE) 10 2023 001 757.4

(51) Int. Cl. B62D 25/08; B60R 5/02; B60S 1/50

(52) U.S. Cl. CPC B62D 25/08; B60R 5/02; B60S 1/50

(57) ABSTRACT

In order to create a front storage space which fulfils a further function along with that of storing a load, a front storage space for an electrically drivable motor vehicle includes a housing which delimits a storage space capacity with a housing wall. The housing wall defines a cavity for a liquid inside at least a partial region of the housing wall.

### BACKGROUND AND SUMMARY OF THE INVENTION

The invention relates to a front storage space for an electrically drivable motor vehicle.

Such front storage spaces, which are typically referred to as a “frunk” (a portmanteau of “front” and “trunk”), are typically used in electrically drivable motor vehicles in the region of a front unit powertrain compartment, as there is now a suitable space for storing a load in this region due to the omission of an internal combustion engine.

A front storage space of such type is already known from DE 10 2020 134 081 A1 and comprises a housing which delimits a storage space capacity with a housing wall. The housing there is divided into a storage space and into a technical space, inside which, for example, other components or the like are accommodated.

As autonomous driving continues to develop, in addition the requirements placed on cleaning the sensor system, for example corresponding cameras, lidars or the like, located in or on the vehicle are becoming increasingly greater. In order to be able to ensure optimum functioning of this sensor system, depending on weather conditions, for example when driving in the rain, dust or the like, a significant amount of cleaning liquid is needed, with which the respective cameras, lidars or similar sensor elements can be cleaned from time to time, in order to ensure optimum functioning thereof. Together with the need for cleaning liquid, for example for the front windscreen, a significantly greater volume of cleaning liquid, for example of about double or triple the previous amount, therefore has to be provided in comparison to the previous level, without the driver being forced to refill this resource excessively often. However, the storage of an appropriate container of, for example, about 15 to 20 liters capacity inside the motor vehicle without this resulting in a significant restriction for the arrangement of the remaining components (package) raises significant problems.

The object of the present invention is therefore to create a front storage space of the above-mentioned type, which has a further function along with that of storing a load.

In order to create a front storage space which fulfils a further function along with that of storing a load, it is provided according to the invention that a cavity for a liquid, in particular washing liquid, is designed at least inside a partial region of the housing wall of the housing of the front storage space. In this case, the invention makes use of the fundamental idea that the housing of the front storage space is typically dimensioned to be relatively large and therefore a small loss of load capacity may cause a significant gain with regard to a volume of a cavity when, for example, the corresponding housing wall of the housing of the front storage space is designed to be at least partially double-walled and thus as a cavity. As the dimensions of the front storage space are very large in comparison to other installation spaces, a relatively large volume can be generated by a correspondingly double-walled design of the respective housing wall of the housing or the storage space shell. This goes hand in hand with just a slight reduction in the storage space capacity used to accommodate a load.

In a further embodiment of the invention, it has proven to be advantageous when the housing wall has, at least in the corresponding partial region, an inner wall and an outer wall which delimit the cavity. Thus, the desired cavity for accommodating the liquid can be created by a correspondingly double-walled design of the housing wall at least in the partial region.

Furthermore, it has proven advantageous when a cavity for a liquid is designed at least substantially inside the entire housing wall. For this purpose, preferably the at least approximately entire housing wall is designed to be double-walled with an inner wall and an outer wall. Thus, overall, a cavity with a large volume can be created, in order to be able to accommodate a volume of 15 to 20 litres of washing liquid, for example.

Furthermore, it is advantageous when the housing has a base region which is recessed with respect to an adjacent base region and in the region of which the housing wall has a connection for the washing liquid. Thus, the washing liquid collects in the recessed base region in a simple manner when it is running out, for example, even if the vehicle is parked slightly on a slope, for example. Thus, it can be ensured in this way that liquid is available to be withdrawn at the corresponding connection until the housing or the cavity is almost empty.

In a further embodiment of the invention, it has proven advantageous when the housing is produced from a plastic. A plastic part of such type can be designed in particular as a blow-moulded part or similar. This means that a double-walled plastic component can be made in a simple manner.

In a further embodiment of the invention, a filling opening for the liquid is arranged inside the housing. This enables particularly simple filling with the washing liquid.

In this context, it has also proven advantageous when the inner wall of the housing wall is bulged in a corner region of the housing and has an at least substantially level upper wall region in which the filling opening is arranged. This makes it easy to fill up the liquid, and in particular a fill level—if necessary by providing a fill level indicator—can also be checked in a particularly favorable manner.

Lastly, is has proven advantageous when the housing wall has at the upper end a circumferential edge which is designed to be free of cavities. Thus, for example, a seal can be attached at the upper end of the housing, by means of which seal the front storage space can be sealed, for example, from a separate cover or a front bonnet of the motor vehicle.

Further advantages, features and details of the invention become apparent from the following description of a preferred exemplary embodiment and with reference to the drawings. The features and combinations of features mentioned above in the description as well as the features and combinations of features mentioned below in the description of the figures and/or shown alone in the figures can be used not only in the combination indicated in each case, but also in other combinations or on their own, without leaving the scope of the invention.

### BRIEF DESCRIPTION OF THE DRAWINGS

FIG. 1 is a perspective view of a front storage space on an electrically drivable motor vehicle having a housing which delimits a storage space capacity with a housing wall towards the bottom and on the outer circumference;

FIG. 2 is a perspective sectional view through the housing of the front storage space, wherein it can be seen that the housing wall is designed to be double-walled with an inner wall and an outer wall and a cavity for a liquid is designed at least substantially inside the entire housing wall; and

FIG. 3 is a sectional view from the side through the housing according to FIGS. 1 and 2, which again illustrates that the entire housing wall is designed at least substantially to be double-walled and forms a cavity for the liquid.

### DETAILED DESCRIPTION OF THE DRAWINGS

In the figures, identical or functionally identical elements are provided with the same reference numerals.

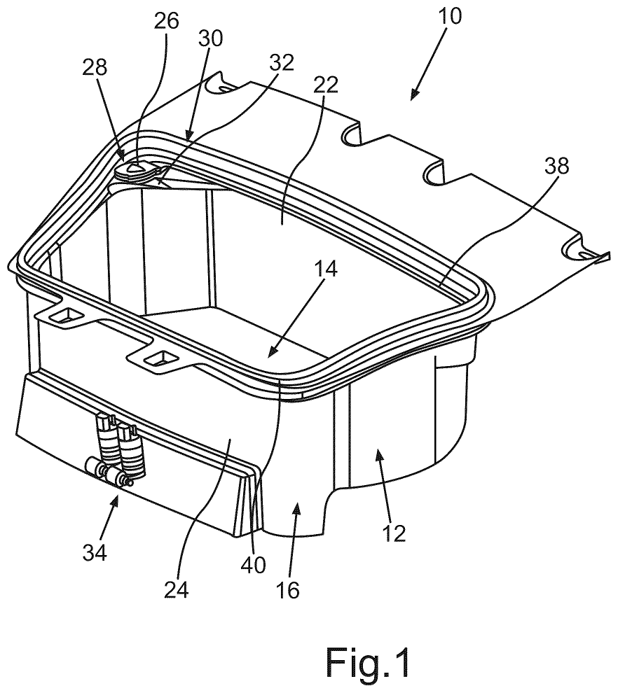

FIG. 1 shows in a perspective view a front storage space for an electrically drivable motor vehicle (BEV, PHEV). This front storage space comprises a housing 10, which in the present case is arranged below a front bonnet in a front powertrain compartment of the motor vehicle, that cannot be seen further. In this case, typically, due to a lack of a large internal combustion engine, there is a correspondingly large installation space in a central centre region of the front powertrain compartment in which to arrange the front storage space or its housing 10.

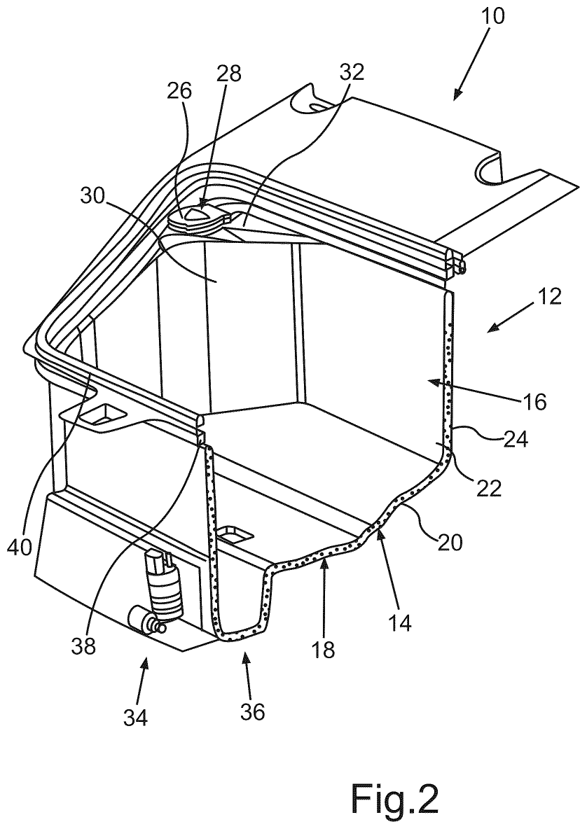

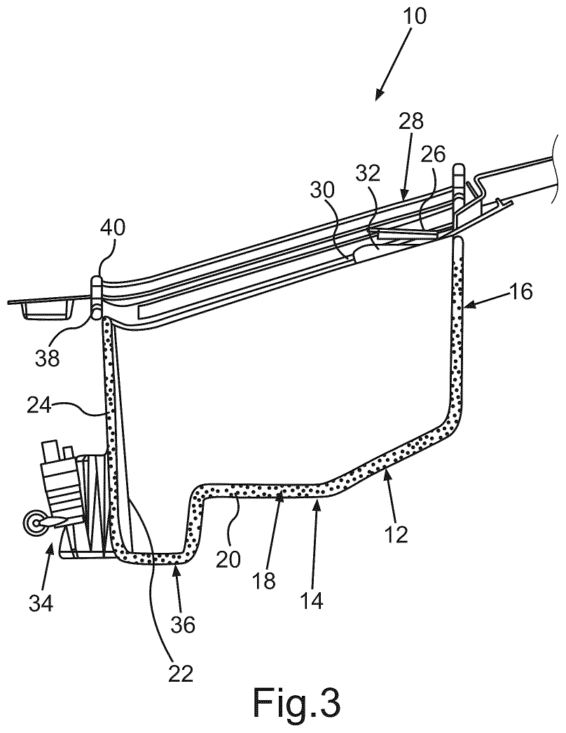

According to FIGS. 2 and 3, which show a perspective sectional view and a sectional view from the side of the housing 10, a storage space capacity is delimited by this housing with a housing wall 12. This housing wall 12 comprises here substantially a base region 14 and an outer circumferential side wall region 16. Overall, the housing 10 has a trough-like design with a substantially prismatic basic shape.

In order to be able to accommodate a liquid, in particular washing liquid for a windscreen wiper system and for plurality of sensors, such as cameras, lidars or similar, a cavity 18 for this liquid 20 is designed at least inside a partial region of the housing wall 12.

In the present exemplary embodiment shown, the cavity 18 for the liquid is designed at least substantially inside the entire housing wall 12, i.e., both in the base region 14 as well as in the side wall region 16. The cavity 18 is therefore formed by the housing wall 12 having, in the base region 14 and in the side wall region 16, a respective inner wall 22 and a respective outer wall 24 which delimit the cavity 18. In other words, the housing wall 12 is designed to be at least substantially completely double-walled both in the base region 14 as well as in the side wall region 16, so that the complete storage space capacity can be surrounded by liquid at least substantially. This means that a large cavity 18 is created with a relatively low loss of storage space capacity, so that, for example, about 15 to 20 litres of washing liquid or similar can be accommodated by the housing 10. As explained above, in this case it is conceivable that only one partial region of the housing wall 12 is used in order to form the cavity 18.

In particular, it can also be seen from FIGS. 1 and 2 that a filling opening 28 for the liquid, sealed for example, with a cover 26, is arranged inside the housing 10 in the region of the storage space capacity. In the present exemplary embodiment shown, for this purpose the inner wall 22 of the side wall region 16 of the housing wall 12 is widened inwards or bulged in a corner region 30 of the housing 10 and comprises an at least substantially level upper wall region 32 in which the filling opening 28 is arranged. In this corner region 30, for example, a display window or similar display device can be provided, by means of which the fill level of the liquid can be seen inside the housing 10.

In a lower front end region, a connection 34 via which the liquid can be withdrawn can be seen. This connection 34 is provided in a recessed base region 36 adjacent to the remaining base region 14 and enables the liquid to be withdrawn to approximately the lowest point of the cavity 18 within the housing 10, even if the vehicle is on a slight slope, for example. In this case, the connection 34 penetrates the outer wall 24 in order to produce a connection to the cavity 18.

In particular, it can also be seen from FIG. 3 that the housing wall 12 has at the upper end a circumferential edge 38 which is designed to be free of cavities. Therefore, a seal 40 can be arranged in a simple manner around the outer circumference of this edge, in order, for example, to close off the housing 10 from a cover, by means of which the front storage space can be closed. This cover can be designed separately, or the front bonnet of the powertrain compartment is used to interact with its underside with the seal 40 to close the storage space.

1.-8. (canceled)

9. A front storage space for an electrically drivable motor vehicle, comprising:
a housing (10) which delimits a storage space capacity with a housing wall (12);
wherein the housing wall (12) defines a cavity (18) for a liquid (20) inside at least a partial region of the housing wall (12).

10. The front storage space according to claim 9, wherein the housing wall (12) has, at least in the partial region, an inner wall (22) and an outer wall (24) which delimit the cavity (18).

11. The front storage space according to claim 9, wherein the housing wall (12) defines the cavity (18) inside an entirety of the housing wall (12).

12. The front storage space according to claim 9, wherein the housing (10) has a base region (36) which is recessed with respect to an adjacent base region (14) and wherein a connection (34) for the liquid (20) is provided at the base region (36).

13. The front storage space according to claim 9, wherein the housing (10) is plastic.

14. The front storage space according to claim 9, wherein a filling opening (28) for the liquid (20) is disposed inside the housing (10).

15. The front storage space according to claim 14, wherein an inner wall (22) of the housing wall (12) is bulged in a corner region (30) of the housing (10) and has an upper wall region (32) and wherein the filling opening (28) is disposed in the upper wall region (32).

16. The front storage space according to claim 9, wherein the housing wall (12) has at an upper end a circumferential edge (38) which is free of the cavity.
